(19) United States
(12) Patent Application Publication
(10) Pub. No.: US 2017/0086433 A1
(43) Pub. Date: Mar. 30, 2017

(54) Arrow Shaft for Bowfishing Having Carbon Fiber Core

(71) Applicant: AMS, LLC, Stratford, WI (US)

(72) Inventor: Jeff Braun, Stratford, WI (US)

(21) Appl. No.: 15/274,298

(22) Filed: Sep. 23, 2016

Related U.S. Application Data
(60) Provisional application No. 62/232,186, filed on Sep. 24, 2015.

(51) Int. Cl. A01K 81/04; F42B 6/08; F42B 6/06

(52) U.S. Cl. CPC A01K 81/04; F42B 6/06; F42B 6/08

(57) ABSTRACT

A pultruded arrow shaft for bow fishing in which a carbon fiber is placed in a core and then surrounded by fiberglass composite and provides comparable stiffness benefits to the arrow shaft as to that provided by outer wrappings or spines of carbon fiber yet with improved resistance to damage from the outer protective fiberglass fibers.

### CROSS REFERENCE TO RELATED APPLICATION

This application claims priority to U.S. Provisional Patent Application No. 62/232,186. tiled on Sep. 24. 2015, which is herein incorporated by reference.

### BACKGROUND OF THE INVENTION

The present invention relates generally to arrows suitable for use with bowfishing and in particular to an improved arrow shaft for use in bowfishing.

Bowfishing is an archery technique using specialized bows and arrows for fishing. A bowfishing bow may have a lower draw weight than a standard bows as well as a constant draw to allow rapid and frequent shooting without tiring the archer. The bowfishing bow may have bowfishing line stored in a canister or reel attached to the bow. One end of ₜhe bowfishing line is attached to the arrow so that when the arrow is released the line pays out allowing the arrow and fish to be retrieved by reeling the line in A bowfishing reel suitable for use in this purpose is described in U.S. Pat. Nos. 4,1383,516 and 6,634,350 by the inventor of the present invention and hereby incorporated by reference. The line may lx attached to the arrow using a slide that moves freely up and down the arrow shaft. Before the arrow is released, the slide may be positioned in front of the arrow rest and bowstring and may remain in front of the arrow rest as the arrow is released to reduce risk of entangling either the bow or the bowstring. Slides suitable for this purpose are described in U.S. Pat. No. 6,517,453 also by the inventor of the present invention and hereby incorporated by reference.

The arrows used for bowfishing ate normally fashioned out of high-strength fiberglass or carbon fiber composites to better survive impact with a stony bottom of a lake or stream. Fiberglass arrows are normally constructed by a pultrusion technique in which fiberglass fibers impregnated with a thermosetting resin, are pulled through heated die wherein the thermosetting resin cures to create a strong, composite rod.

Carbon fiber composites may be constructed by wrapping carbon fibers about a mandrel that is then removed to provide a strong but light carbon fiber tube. In a hybrid technique developed by the assignee of the present application, carbon fiber “spines” may be added to a fiberglass arrow during the pultrusion process. These spines provide carbon fibers in bands around the periphery of the fiberglass pultrusion visible as stripes extending along the length of the arrow and spaced evenly around its circumference.

Carbon fiber arrows provide greater shaft stiffness, reducing the tendency of the arrow to flex during the flight. Carbon fiber, however is more susceptible to damage particularly when the arrow strikes objects as is more common in bowfishing where the arrow may recoil off of river stones and the like.

### SUMMARY OF THE INVENTION

The present invention provides a pultruded arrow shaft for bow fishing in which a carbon fiber is placed in a core and then surrounded by fiberglass composite. The present inventors have determined that a carbon fiber core can provide comparable stiffness benefits to the arrow shaft as to that provided by outer wrappings or spines of carbon fiber yet with improved resistance to damage from the outer protective fiberglass fibers.

Specifically, the present invention provides a bowfishing arrow shaft having a cylindrical shaft body extending along a shaft axis having a central portion of carbon fibers embedded in a matrix material and generally aligned with the shaft axis and surrounded by a tubular sheath of fibers that are not carbon fibers embedded in the matrix material.

It is thus a feature of at least one embodiment of the invention to allow the carbon fibers core to provide improved strength while also being shielded from damage that may occur when the arrow shaft contacts and recoils after hitting river stones at the bottom of a lake or stream.

The matrix material may be a thermosetting polymer resin. The thermosetting polymer resin may be at least one of a polyester and epoxy.

It is thus a feature of at least one embodiment of the invention to embed the fibers within a hardened outer matrix material to prevent the fibers from “splintering” off the arrow shaft after hitting a hard surface.

The cylindrical shaft body may have a nock having a bifurcated rearward portion providing opposed fingers for fitting a bowstring therebetween wherein the cylindrical shaft body has a rear end receiving an interlining end of the nock. The cylindrical shaft body may have a conically tapered rear boss for receiving a nock that has a forward bore adapted to receive the conically tapered rear boss of the shaft body to align the nock with the arrow axis. The cylindrical shaft body may have an arrow tip having a rearward bore receiving the front end of the shaft body to align the arrow tip with the arrow axis wherein the cylindrical shaft body has a front end interfitting with the arrow tip.

A diameter of the cylindrical shaft body may be approximately 0.2-0.4 inches. A length of the cylindrical shaft body may be approximately 20-35 inches long.

It is thus a feature of at least one embodiment of the invention that the arrow shaft conform to a conventional bowfishing arrow shaft.

The nock may be transparent.

It is thus a feature of at least one embodiment of the invention to allow a consumer to view the carbon core layers of the arrow shaft through the nock and to confirm the quality of the arrow core.

The present invention may also provide a method of manufacturing a bowfishing arrow shaft wherein the arrow tip includes a cylindrical shaft body extending along a shaft axis having a central portion of carbon fibers embedded in a first matrix material and generally aligned with the shaft axis and surrounded by a tubular sheath of fibers that are not carbon fibers embedded in a second matrix material, the method including the steps of drawing a plurality of fiberglass fibers and carbon fibers through a resin bath of matrix material; passing the matrix impregnated fiberglass fibers along an axis through an outer positioned guide defining an outer sheath; passing the matrix Impregnated carbon fibers through an inner positioned guide defining an inner sheath coaxially within the outer sheath; pressing the matrix impregnated fiberglass fibers and matrix impregnated carbon fibers into a rod shape; and heating the matrix material to solidify the matrix material,

It is thus a feature of at least one embodiment of the invention to manufacture the arrow shaft using a single pass pultrusion process.

The outer positioned guide may include a plurality of holes arranged in an outer ring. The inner positioned guide may include a plurality of holes arranged in a center ring concentric with the outer ring.

The method may include passing the matrix impregnated fiberglass fibers and matrix impregnated carbon fibers through a collimating die substantially equal to the outer diameter of the arrow shaft.

It is thus a feature of at least one embodiment of the invention to assist with alignment of the outer core in a manner that is concentric with the inner core in order to shield the inner core.

The matrix material may be heated by the die.

The present invention may provide a bowfishing arrow assembly having a solid arrow shaft extending along an axis and having a front end and a rear end; a nock having a bifurcated rearward portion providing opposed fingers for fitting a bowstring therebetween and having a forward portion adapted to interfit with the rear end of the arrow shaft to align the nook with the arrow axis; and an arrow tip having a pointed forward portion and a rearward portion adapted to interfit with the front end of the shaft body to align the arrow tip with the arrow axis; wherein the arrow shaft has a central portion of carbon fibers embedded in a first matrix material and generally aligned with the shaft axis and surrounded by a tubular sheath of fibers that are not carbon fibers embedded in a second matrix material.

An adapter may have a rearwardly open bore receiving the front end of the arrow shaft to align an axis of the adapter with the arrow axis by interfitting the bore and front end and having a forwardly opening bore with substantially parallel walls receiving the arrow tip. The adapter may include at least one pivoting barb attached to the adapter and pivotable rearwardly toward the arrow shaft.

These particular features and advantages may apply to only some embodiments falling within the claims and thus do not define the scope of the invention.

### BRIEF DESCRIPTION OF THE DRAWINGS

FIG. 1 is a fragmentary side elevational view of an arrow shaft constructed according to the present invention as attached to a nock and arrow point;

FIG. 2 is a cross-sectional view along line 2-2 of FIG. 1 showing the dimensions of the carbon fiber core;

FIG. 3 is an exploded perspective view of an attachment between the nock and the arrow shaft of the present invention;

FIG. 4 is a side elevational detailed view of the nock attached to the arrow shaft showing visibility of the carbon core through a transparent or semitransparent nock;

FIG. 5 is a perspective view of a pultrusion fiber guide that may be used to produce a carbon fiber core surrounded by fiberglass in a single pultrusion operation; and

FIG. 6 is a perspective fragmentary view of an alternative method of fabricating the arrow of the present invention by using a carbon fiber core as a mandrel around which fiberglass is wound.

### DETAILED DESCRIPTION OF THE INVENTION

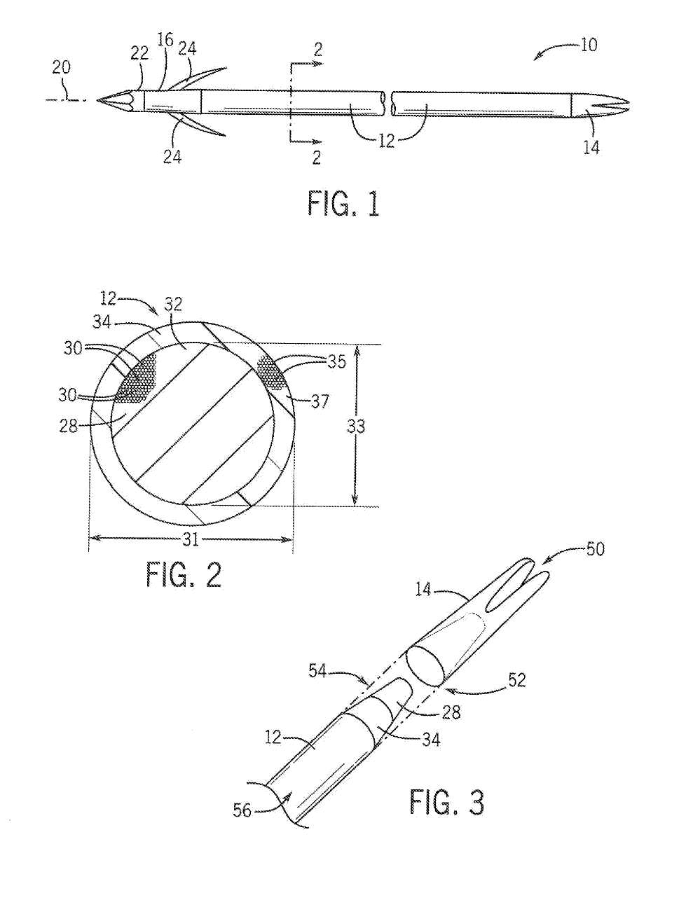

Referring now to FIG. 1, an arrow 10 for use with the present invention may provide for an arrow shaft 12 having a cylindrical cross-section, for example, less than 0.5 inches in diameter or less than 0.25 inches in diameter or between 0,2 and 0.4 inches in diameter or between 0.3 and 0.35 inches in diameter or approximately 5/16 inches in diameter, and less than forty inches long or less than thirty-five inches long or between twenty and thirty-five inches long or between thirty and thirty-five inches long or approximately thirty-two inches long. A rear end of the arrow shaft 12 provides an arrow nock 14 for receiving the bowstring when the arrow is shot.

A front end of the arrow shaft 12 may attach to an adapter 16, for example, with the front end of the arrow shaft 12 received within a blind bore socket (not shown) in the adapter 16 and held therein with epoxy or the like. The adapter 16 may provide a generally cylindrical metal body supporting the bore socket at a rear end and extending along an axis 20 common to the arrow shaft 12 to terminate at an arrow tip 22. The arrow tip 22 may be, for example, attached to the adapter 16 by means of a threaded bore receiving a threaded boss (neither shown) extending from the adapter 16.

Pivoting barbs 24 may be attached to the adapter 16 to extend outwardly from the adapter 16 and back toward the arrow shaft 12 to help retain a fish on the arrow 10 after the arrow tip 22, the adapter 16 and barbs 24 have passed through a fish. A bow fishing arrowhead providing for an adapter 16, arrow tip 22, and barbs 24 is described in U.S. patent application Ser. No. 14/457,677 filed Aug. 12, 2014, assigned to the same assignee as the present invention and hereby incorporated by reference.

Referring now to FIG. 2, the arrow shaft 12 may provide for a center cylindrical core 28 of carbon fibers 30 embedded in a hardened matrix material 32 of thermosetting polymer resin such as polyester or epoxy. The carbon fibers 30 are oriented to extend along axis 20 and may be exclusive of other fiber types or mixed with other fiber types such as fiberglass.

Surrounding the cylindrical core 28 of carbon fibers 30 and matrix material 32 is an outer tubular sheath 34 exclusive of carbon fibers but including fiberglass fibers 35 embedded in a matrix material 37, for example, being a thermosetting polymer resin such as polyester or epoxy. In one embodiment, the matrix material 37 and matrix material 32 may be identical and the core 28 and tubular sheath 34 are formed simultaneously in a co-pultrusion process described below. Other non-carbon fibers may be substituted for or mixed with the fiberglass fibers 35 in the tubular sheath 34, for example, other polymer materials such as Kevlar™ (aramid fibers).

The following dimensions of the cylindrical core 28 and the tubular sheath 34 are contemplated:

TABLE I

| | | | Diameter | |
|---|---|---|---|---|
| | Outside | | percentages | Area |
| Outside | diameter | Wall | (diameter of | percentages |
| diameter of | (33) of | thickness | core 28/outside | (area of core |
| arrow shaft | cylindrical | of tubular | diameter of | 28/area of |
| (31) | core 28 | sheath 34 | arrow shaft) | arrow shaft) |
| 0.313 inches | 0.188 inches | 0.063 inches | 60% | 36% |
| 0.313 inches | 0.156 inches | 0.078 inches | 50% | 25% |
| 0.313 inches | 0.125 inches | 0.94 inches | 40% | 16% |

The percentage of the cylindrical core 28 compared to the total area of the arrow shaft may be greater than 30% or greater than 20% or between 15-35%.

The following typical characteristics of the carbon fibers 30 (such as intermediate carbon and high strength carbon), fiberglass fibers 35 (such as E-glass fiber and S-glass fiber) and Kevlar are contemplated:

TABLE II

| | | Young's | Tensile | Approx. |
|---|---|---|---|---|
| | Density | Modulus | Strength | Strain of |
| Fiber Type | (g/cc) | (msi) | (ksi) | Failure |
| Intermediate Carbon (IM) | 1.76 | 33 | 530 | 1.6% |
| High Strength Carbon (HS) | 1.78 | 42 | 770 | 1.8% |
| Kevlar | 1.44 | 16.4 | 430 | 2.60% |
| E-Glass fiber | 2.55 | 10 | 500 | 5.00% |
| S-Glass fiber | 2.49 | 12 | 665 | 5.30% |

The carbon fibers 30 may be an intermediate carbon or a high strength carbon. The carbon fibers 30 are contemplated to have a density greater than Kevlar and less than the fiberglass fibers 35. The density of the carbon fibers 30 may be between 1.7 and 1.8 g/cc or between 1.75 and 1.8 g/cc or approximately 1.76 g/cc or 1.78 g/cc. The carbon fibers 30 are contemplated to have a young's modulus greater than Kevlar and the fiberglass fibers 35. The young's modulus may be greater than 20 msi or greater than 30 msi or between 30 and 50 msi or between 30 and 45 msi or approximately 33 msi or 42 msi. The carbon fibers 30 are contemplated to have a tensile strength greater than Kevlar and may be greater than or less than the fiberglass fibers 35 depending on the type of fiber, The tensile strength may be between 500 and 800 ksi or approximately 530 ksi or approximately 770 ksi. The carbon fibers 30 are contemplated to have an approximate strain of failure less than Kevlar and the fiberglass fibers 35. The approximate strain of failure may be less than 2.5% or less than 2% or between 1-2% or between 1.5-2% or approximately 1.6% or 1.8%.

The Kevlar is contemplated to have a density less than carbon fibers 30 and the fiberglass fibers 35. The density of Kevlar may be between 1 and 2 g/cc or between 1 and 1.5 g/cc or approximately 1.44 g/cc. The Kevlar is contemplated to have a young's modulus greater than the fiberglass fibers 35 but less than the carbon fibers 30. The young's modulus may be less than 30 msi or less than 20 msi or between 10 and 20 msi or between 15 and 20 msi or approximately 16.4 msi. The Kevlar is contemplated to have a tensile strength less than the carbon fibers 30 and fiberglass fibers 35. The tensile strength may be between 400 and 500 ksi or approximately 430 ksi. The Kevlar is are contemplated to have an approximate strain of failure greater than the carbon fibers 30 and less than the fiberglass fibers 35. The approximate strain of failure may be greater than 2% or greater than 2.5% or between 2-4% or between 2.5-4% or approximately 2.6%.

The fiberglass fibers 35 may be E-glass fiber or S-glass fiber. The fiberglass fibers 35 are contemplated to have a density greater than Kevlar and the carbon fibers 30. The density of the fiberglass fibers 35 may be between 14 and 2.6 g/cc or between 2.45 and 2.6 g/cc or approximately 2.55 g/cc or 2.49 g/cc. The fiberglass fibers 35 are contemplated to have a young's modulus less than Kevlar and the carbon fibers 30. The young's modulus may be less than 30 msi or less than 20 msi or between 10 and 20 msi or between 10 and 15 msi or approximately 10 msi or 12 msi. The fiberglass fibers 35 are contemplated to have a tensile strength greater than Kevlar and may be greater than or less than the carbon fibers 30 depending on the type of fiber. The tensile strength may he between 500 and 700 ksi or approximately 500 ksi or approximately 665 ksi. The fiberglass fibers 35 are contemplated to have an approximate strain of failure greater than Kevlar and the carbon fibers 30. The approximate strain of failure may be greater than 2% or greater than 2.5% or between 5-6% or between 5-5.5% or approximately 5% or 5.3%.

Referring now to FIG. 5, fabrication of the arrow shaft 12 may be done by a single pass pultrusion in which fiberglass fibers 35 may be drawn from spools (not shown) through a resin bath 36 of matrix material 32, 37 on either side of carbon fibers 30 drawn from separate spools (not shown) through the resin bath 36. A specially designed fiber guide 38 may provide for an outer ring 40 of guide holes 42 receiving the fiberglass fibers 35 after impregnation with the matrix material 32, 37 and a center ring 44 of holes 46 receiving the carbon fibers 30 after impregnation with a matrix material 32, 37. The center ring 44 is concentric within the outer ring 40.

Fiberglass fibers 35 and carbon fibers 30, as oriented by the guide 38, pass through a second collimating guide 48 substantially equal to the outer diameter of the arrow shaft 12 and then are received by the cylindrical opening of a heated die 50 that serves to press the fiberglass fibers 35, carbon fibers 30, and matrix material 32, 37 into a rod shape and to heat the matrix material 32 and 37 to solidify the matrix material 32 and 37.

A pulling mechanism on the far side of the heated die 50 provides continued advancement of the fibers 35 and carbon fibers 30 through the guide 38, collimating guide 48, and heated die 50 as is generally understood in art. The resulting shaft 12 receive from the heated die 50 may be cut to length, for example, by a moving saw during the continuous process. A centerless grinder may be used to provide a surface finish and final diameter to the outer tubular sheath 34 without abrading or damaging the core 28.

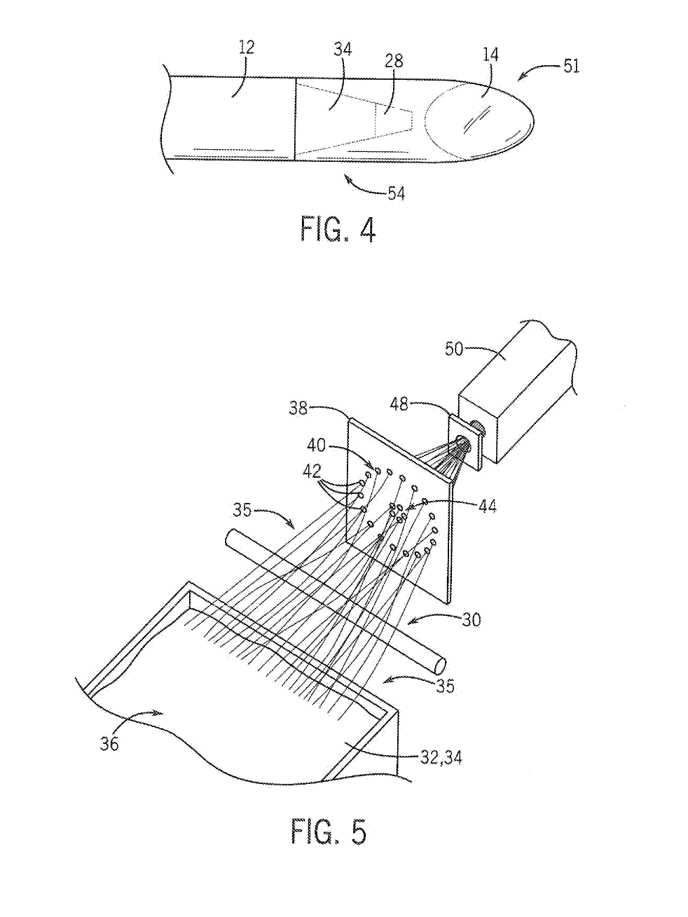

Referring now to FIG. 3, a transparent nock 14 may have a slot 51 for receiving a bowstring at one end and a conical bore 52 for receiving a corresponding conical sharpened end 54 of the shaft 12. The nock 14 may be attached to the sharpened end 54 with a transparent adhesive such as an epoxy or the like. It will be appreciated that the sharpening process of the sharpened end 54 will reveal the core 28 beneath the tubular sheath 34. Referring now also to FIG. 4, the nock 14 may be constructed of a transparent thermoplastic so that the core 28 may be viewed through the nock 14 to provide the end consumer with a confirmation of the quality of the arrow core which otherwise may not be visible beneath the tubular sheath 34.

The outer portions of the sheath may include printed indicia indicating the name of the manufacturer, the size of the core, and other pertinent information for the consumer.

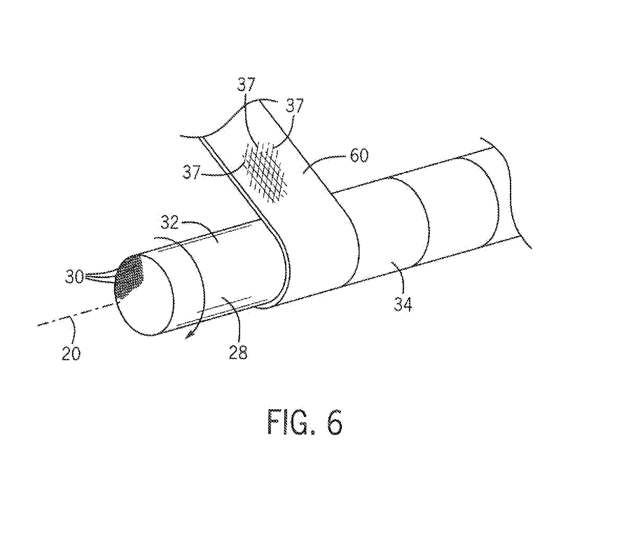

Referring now to FIG. 6, in an alternative manufacturing technique, the carbon fiber core 28 may be pre-manufactured, for example, by pultrusion or other known technique, and then used as a rigid mandrel to receive a fiberglass tape 60 spirally wrapped around the carbon fiber core 28 as the carbon fiber core 28 is rotated about axis 20. The fiberglass tape 60 may be pre-impregnated with a hardening liquid polymer matrix material 37 to form the tubular sheath 34 after the liquid polymer hardens matrix material 37. It will also be appreciated that the fiberglass tape 60 may be alternatively pre-formed into a tubular sheath 34 using a separate mandrel (not shown) that is removed and then the carbon fiber core 28 inserted into the preformed tubular sheath 34, the former glued into a center of the tubular sheath 34.

Generally will be appreciated that the solid carbon fiber center may be surrounded with a more ductile composite material either by protrusion, gluing, or welding.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What I claim is:

1. A bowfishing arrow shaft comprising:
a cylindrical shaft body extending along a shaft axis having a central portion of carbon fibers embedded in a matrix material and generally aligned with the shaft axis and surrounded by a tubular sheath of fibers that are not carbon fibers embedded in the matrix material.

2. The bowfishing arrow shaft of claim I wherein the matrix material is a thermosetting polymer resin.

3. The bowfishing arrow shaft of claim 2 wherein the thermosetting polymer resin is at least one of a polyester and epoxy.

4. The bowfishing arrow shaft of claim I further including a nock having a bifurcated rearward portion providing opposed fingers for fitting a bowstring therebetween wherein the cylindrical shaft body has a rear end receiving an interfitting end of the nock,

5. The bowfishing arrow shaft of claim 1 wherein the cylindrical shaft body has a conically tapered rear boss for receiving a nock that has a forward bore adapted to receive the conically tapered rear boss of the shaft body to align the nock with the arrow axis.

6. The bowfishing arrow shaft of claim 4 wherein the nock is transparent.

7. The bowfishing arrow shaft of claim 1 further including an arrow tip having a rearward bore receiving the front and of the shaft body to align the arrow tip with the arrow axis wherein the cylindrical shaft body has a front end interfitting with the arrow tip.

8. The bowfishing arrow shaft of claim 1 wherein a diameter of the cylindrical shaft body is between 0.2 and 0.4 inches.

9. The bowfishing arrow shaft of claim 7 wherein a length of the cylindrical shaft body is between 20 and 35 inches long.

10. A method of manufacturing a bowfishing arrow shaft wherein the arrow tip comprises a cylindrical shaft body extending along a shaft axis having a central portion of carbon fibers embedded in a first matrix material and generally aligned with the shaft axis and surrounded by a tubular sheath of fibers that are not carbon fibers embedded in a second matrix material, the method comprising the steps of
drawing a plurality of fiberglass fibers and carbon fibers through a resin bath of matrix material;
passing the matrix impregnated fiberglass fibers along an axis through an outer positioned guide defining an outer sheath concentric about the axis;
passing the matrix impregnated carbon fibers through an inner positioned guide defining an inner sheath coaxially within the outer sheath;
pressing the matrix impregnated fiberglass fibers and matrix impregnated carbon fibers into a rod shape; and
heating the matrix material to solidify the matrix material.

11. The method of claim 10 wherein the outer positioned guide includes a plurality of holes arranged in an outer ring.

12. The method of claim II wherein the inner positioned guide includes a plurality of holes arranged in a center ring concentric with the outer ring.

13. The method of claim 10 further comprising the step of:
passing the matrix impregnated fiberglass fibers and matrix impregnated carbon fibers through a collimating die substantially equal to the outer diameter of the arrow shaft.

14. The method of claim 10 wherein the matrix material is heated by the die.

15. A bow fishing arrow assembly comprising:
a solid arrow shaft extending along an axis and having a front end and a rear end;
a nock having a bifurcated rearward portion providing opposed fingers for fitting a bowstring therebetween and having a forward portion adapted to interfit with the rear end of the arrow shaft to align the nock with the arrow axis; and
an arrow tip having a pointed forward portion and a rearward portion adapted to interfit with the front end of the shaft body to align the arrow tip with the arrow axis;
wherein the arrow shaft has a central portion of carbon fibers embedded in a first matrix material and generally aligned with the shaft axis and surrounded by a tubular sheath of fibers that are not carbon fibers embedded in a second matrix material.

16. The assembly of claim 15 further comprising an adapter having a rearwardly open bore receiving the front end of the arrow shaft to align an axis of the adapter with the arrow axis by interfitting the bore and front end and having a forwardly opening bore with substantially parallel walls receiving the arrow tip.

17. The assembly of claim 16 wherein the adapter includes at least one pivoting barb attached to the adapter and pivotable rearwardly toward the arrow shaft.
